(19) United States
(12) Patent Application Publication
(10) Pub. No.: US 2007/0121438 A1
(43) Pub. Date: May 31, 2007

(54) METHOD OF TESTING AN OPTICAL INFORMATION MEDIUM AND OPTICAL INFORMATION MEDIUM TESTING APPARATUS

(75) Inventors: Takashi YAMADA, Tokyo (JP); Tatsuya KATO, Tokyo (JP); Tomoki USHIDA, Tokyo (JP); Hideki HIRATA, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 11/560,010

(22) Filed: Nov. 15, 2006

(30) Foreign Application Priority Data
Nov. 28, 2005 (JP) 2005-341968

(51) Int. Cl. G11B 7/00

(52) U.S. Cl. 369/44.25; 369/44.28

(57) ABSTRACT

A method of testing an optical information medium and an optical information medium testing apparatus compare a voltage of a tracking error signal generated based on return light from the optical information medium received by an optical pickup and a reference voltage set in advance and judge that a fault is present on the optical information medium when the voltage of the tracking error signal is equal to or greater than the reference voltage.

### BACKGROUND OF THE INVENTION

1. Field of the Invention

The present invention relates to a method of testing an optical information medium and an optical information medium testing apparatus that test whether a fault is present on an optical information medium.

2. Description of the Related Art

One example of a method of testing an optical information medium is disclosed by Japanese Laid-Open Patent Publication No. H09-138979. In this method of testing an optical information medium, when carrying out an optical process (such as initialization) on the optical information medium, faults on the optical information medium are also detected using the light emitted in such optical process. In more detail, faults are detected using a focus error signal generated by calculations carried out on signals outputted from a light detector that has received the light. Accordingly, by using this method of testing an optical information medium, it is possible to detect localized faults such as localized deformation of the substrate of the optical information medium or streak-like faults in the hard coat layer reliably, accurately, and at effectively the same time as an optical process such as initialization. Also, since faults can be detected at the same time as the optical process, it is possible to simplify the apparatus and procedure.

### SUMMARY OF THE INVENTION

However, by investigating the method of testing the optical information medium described above, the present inventors found the following problem. That is, in the method of testing an optical information medium described above, although there is a large change in the voltage of the focus error signal when the irradiation position of laser light outputted from an optical pickup passes directly above a fault such as a bubble or foreign matter on the optical information medium, thereby making it possible to detect such faults on the optical information medium, when the irradiation position of laser light passes close to but not directly above a fault, the change in the voltage of the focus error signal is extremely small. Accordingly, with this method of testing an optical information medium, there is the problem that it may not be possible to detect faults on an optical information medium where faults are not positioned at the centers of the tracks, for example.

The present invention was conceived in view of the problem described above and it is a principal object of the present invention to provide a method of testing an optical information medium and an optical information medium testing apparatus that can detect a fault on an optical information medium with higher reliability.

To achieve the stated object, a method of testing an optical information medium according to the present invention comprises comparing a voltage of a tracking error signal generated based on return light from the optical information medium received by an optical pickup and a reference voltage set in advance and judging that a fault is present on the optical information medium when the voltage of the tracking error signal is equal to or greater than the reference voltage.

According to this method of testing an optical information medium and an optical information medium testing apparatus described below, by judging that a fault such as a bubble or foreign matter is present on the optical information medium when the voltage of the tracking error signal generated based on return light from the optical information medium received by an optical pickup is equal to or greater than the reference voltage, it will be possible to reliably detect a fault such as a bubble or foreign matter in a light transmitting layer (formed by spin coating, for example) of the optical information medium even when the laser light passes over a deformed part in the periphery of the bubble or foreign matter without the laser light passing directly over or in close proximity to the bubble or foreign matter itself, thereby greatly improving the testing precision for the optical information medium.

Testing for the fault using the tracking error signal may be carried out at intervals of a predetermined number of tracks.

According to this method of testing an optical information medium and an optical information medium testing apparatus described below, since a deformed part present in a wide range in the periphery of a bubble or foreign matter in the light transmitting layer can be precisely detected on an optical information medium where such deformed part is present, it is possible to reliably detect a fault by testing only two tracks located at predetermined intervals that are sampled cut of a plurality of tracks present within a range of the size of the deformed part. Therefore, according to the method of testing an optical information medium and the optical information medium testing apparatus, since it is possible to test for a fault across the entire optical information medium by merely judging whether a fault is present at predetermined tracks set at intervals within the range of the size of the deformed part, the testing efficiency can be greatly improved.

Testing for the fault using the tracking error signal may be carried out on the optical information medium that has already been tested using an optical fault testing apparatus.

According to this method of testing an optical information medium, by testing for the fault using the tracking error signal on the optical information medium that has already been tested using an optical fault testing apparatus, testing using the tracking error signal will be carried out only on the optical information medium for which such testing is necessary, which makes it possible to significantly improve the efficiency of fault testing.

An optical information medium testing apparatus according to the present invention includes: an optical pickup that receives return light from an optical information medium and generates a tracking error signal; and a calculation control unit that compares a voltage of the tracking error signal and a reference voltage set in advance and judges that a fault is present on the optical information medium when the voltage of the tracking error signal is equal to or greater than the reference voltage.

The optical information medium testing apparatus may further include a feed mechanism that moves the optical pickup in a radial direction of the optical information medium, and may be constructed so that the calculation control unit controls the feed mechanism to move the optical pickup in the radial direction while judging whether the fault is present at intervals of a predetermined number of tracks.

It should be noted that the disclosure of the present invention relates to the content of Japanese Patent Application 2005-341968 that was filed on 28 Nov. 2005, the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a block diagram of an optical information medium testing apparatus;

FIG. 2 is a block diagram of a signal generating unit;

FIG. 3 is a graph where the voltage of a tracking error signal when laser light is incident on deformed parts of an optical information medium on an inner periphery side and an outer periphery side of a fault such as a bubble is expressed as a proportion of a peak value of the voltage that appears in the tracking error signal during a track jump;

FIG. 4 is a flowchart showing a testing process carried out by the optical information medium testing apparatus; and

FIG. 5 is a flowchart showing the fault testing process in FIG. 4.

### DESCRIPTION OF THE PREFERRED EMBODIMENTS

Preferred embodiments of a method of testing an optical information medium and an optical information medium testing apparatus will now be described with reference to the attached drawings.

First, the construction of an optical information medium testing apparatus 1 will be described with reference to the drawings. Note that as one example, the following describes an optical information medium testing apparatus 1 that tests for faults such as bubbles and foreign matter present in a light-transmitting layer of an optical information medium whose light-transmitting layer has been formed by spin coating.

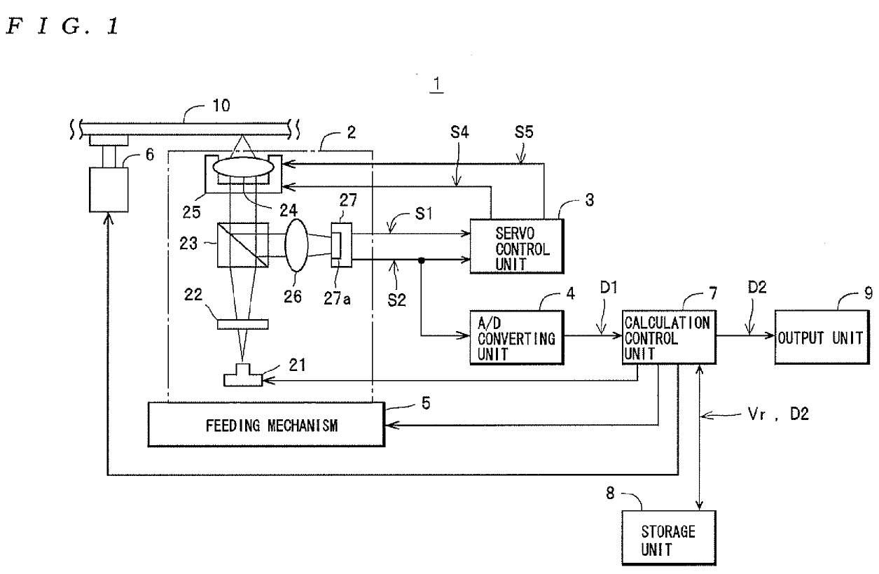

The optical information medium testing apparatus 1 shown in FIG. 1 includes an optical pickup 2, a servo control unit 3, an A/D converting unit 4, a feed mechanism 5, a spindle motor 6, a calculation control unit 7, a storage unit 8, and an output unit 9.

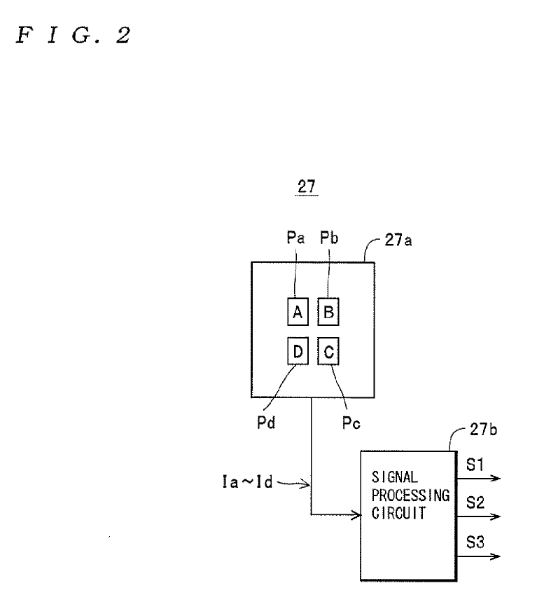

As shown in FIG. 1, the optical pickup 2 includes a laser diode 21, a diffraction grating 22, a beam splitter 23, an objective lens 24, a two-axis actuator 25, a converging lens 26, and a signal generating unit 27, and is constructed to irradiate an optical information medium 10 with laser light, to receive return light from the optical information medium 10, and to generate, based on the return light, an information signal S3 for reproducing information recorded on the optical information medium 10 and also a focus error signal S1 and a tracking error signal S2 (see FIG. 2). When doing so, the diffraction grating 22 divides the laser light emitted from the laser diode 21 into three beams (a main beam and two sub-beams) that are outputted to the beam splitter 23. The main beam and the two sub-beams outputted from the beam splitter 23 are irradiated onto the optical information medium 10 via the objective lens 24. The incident positions of one sub-beam, the main beam, and the other sub-beam are set so as to be arranged in the mentioned order in a direction substantially perpendicular to the track direction of the optical information medium 10, that is, the beams are arranged in the radial direction of the optical information medium 10. The two-axis actuator 25 is constructed of a well-known mechanism (such as an shaft sliding and rotating type actuator or a hinged actuator) and is equipped with a function for moving the objective lens 24 in the optical axis of the objective lens 24 based on an inputted focus control signal S4 and a function for moving the objective lens 24 in a direction that is substantially perpendicular to the track direction of the optical information medium 10 based on an inputted tracking control signal S5.

As shown in FIG. 2, the signal generating unit 27 includes an optical detector 27a and a signal processing circuit 27b. More specifically, as one example, the optical detector 27a includes four light-receiving elements (in the present embodiment, photodiodes, for example) Pa, Pb, Pc, and Pd. As shown in FIG. 2, the four photodiodes Pa, Pb, Pc, and Pd are disposed in the four corners of a virtual square. One side of the virtual square where the two photodiodes Pa and Pb are disposed is parallel to the direction that is substantially perpendicular to the track direction of the optical information medium 10 and another side of the virtual square where the two photodiodes Pa and Pd are disposed is substantially parallel to the track direction of the optical information medium 10. The four photodiodes Pa, Pb, Pc, and Pd arranged in this way are constructed so as to receive return light for the main beam. Out of these photodiodes, the two photodiodes Pa and Pd are respectively capable of receiving return light for one out of the two sub-beams. The other two photodiodes Pb and Pc are respectively capable of receiving return light for the other of the two sub-beams. The photodiodes Pa, Pb, Pc, and Pd respectively Output currents Ia, Ib, Ic, and Id corresponding to the intensity of the received light. The signal processing circuit 27b receives an input of the currents Ia to Id outputted from the photodiodes Pa to Pd and generates the focus error signal S1, the tracking error signal S2, and the information signal S3 based on the currents Ia to Id. More specifically, if the values of the currents Ia, Ib, Ic, and Id are expressed as “A”, “B”, “C”, and “D”, as one example, the signal processing circuit 27b generates the focus error signal S1 by calculating (A+C)−(B+D), generates the tracking error signal S2 by calculating (A+D)−(B+C), and generates the information signal S3 by calculating (A+B+C+D).

The servo control unit 3 receives an input of the focus error signal S1 and the tracking error signal S2, generates the focus control signal S4 based on the focus error signal S1, and generates the tracking control signal S5 based on the tracking error signal S2. The A/D converting unit 4 receives an input of the tracking error signal S2 and converts the tracking error signal S2 to error data D1 showing the voltage of the signal S2. Under the control of the calculation control unit 7, the feed mechanism 5 moves the optical pickup 2 in the radial direction of the optical information medium 10. Under the control of the calculation control unit 7, the spindle motor 6 rotates the optical information medium 10.

The calculation control unit 7 includes a CPU, carries out a fault testing process for the optical information medium 10 based on the error data D1 inputted from the A/D converting unit 4, and also carries out control over the optical pickup 2, the feed mechanism 5, and the spindle motor 6. In the fault testing process, the calculation control unit 7 tests for the presence of faults on the optical information medium 10 at predetermined intervals (for example, 500 μm) in the radial direction. During such testing, when the voltage V1 of the tracking error signal S2 shown by the error data D1 is equal to or greater than a reference voltage Vr stored in the storage unit 8, the calculation control unit 7 judges that a fault such as a bubble or foreign matter is present in the light transmitting layer of the optical information medium 10. This is based on the following data produced by extensive research by the present inventors.

According to research carried out by the inventors, when a bubble or foreign matter is present in the light transmitting layer of the optical information medium 10 being tested by the optical information medium testing apparatus 1 (in particular, an optical information medium 10 where the light transmitting layer has been formed by spin coating), in the periphery of the bubble or foreign matter, there will definitely be a part where the light transmitting layer is deformed (hereinafter such parts are referred to as “deformed parts”). It is thought that when a bubble or foreign matter included in the resin used to form the light transmitting layer flows together with the resin during spin coating, the flow of the resin in the periphery of the bubble or foreign matter will be disturbed and the resin whose flow has been disturbed will become deformed, thereby forming a deformed part. This deformed part will have a size that is around ten to twenty times larger than the size of the bubble or foreign matter, and the thickness of the resin in the deformed part will become gradually thicker toward the bubble or foreign matter. Also, although the tracking error signal S2 has a voltage waveform that is substantially flat in a normal state (i.e., in a state where the tracking error signal S2 is generated based on return light from a light transmitting layer with no bubble or foreign matter), when the tracking error signal S2 is generated based on return light from a deformed part, the voltage will greatly fluctuate in the same way as when the signal is generated based on return light from above the bubble or foreign matter itself. When the tracking error signal S2 is fluctuating, the voltage V1 thereof will increase as the size (for example, the diameter) of the bubble or foreign matter increases. When the voltage V1 of the tracking error signal S2 that is fluctuating due to a fault reaches a voltage peak value Vp that appears in the tracking error signal S2 during a track jump (that is, when the voltage V1 of the tracking error signal S2 reaches 100% of the peak value Vp), tracking servo control by a normal recording/reproducing apparatus is disabled, which can hinder recording or reproducing operations. According to the inventors' research, when the size (for example, the diameter) of the bubble or foreign matter is 40 μm or below, the tracking error signal will remain in a range where tracking servo control is not disabled (i.e., V1<Vp). When the size of the bubble or foreign matter is such that the length in the radial direction of the optical information medium 10 is 40 μm, the deformed part will normally be around 500 μm long in the same direction.

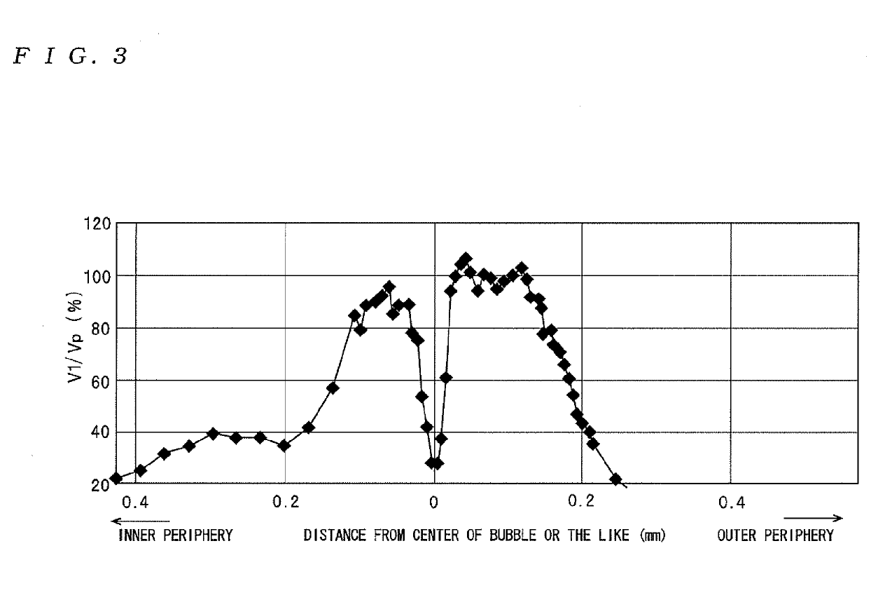

As one example, when return light from a bubble with a diameter of around 43 μm and deformed parts of the optical information medium 10 on both the inner periphery and the outer periphery sides of the bubble is received by the optical pickup 2, the fluctuation in the voltage V1 of the tracking error signal S2 when expressed as a proportion of the peak value Vp of the voltage of the tracking error signal S2 during a track jump is shown in FIG. 3. Note that the horizontal axis in FIG. 3 shows the displacement (distance) from the center of the bubble. As shown in FIG. 3, the voltage V1 of the tracking error signal S2 is around 20% or more of the peak value Vp across a wide range of around 600 μm to 650 μm that includes the bubble. The voltage of the tracking error signal S2 reaches a maximum near the center of the bubble and has a maximum value that slightly exceeds the peak value Vp (the proportion described above is around 105%). Also, although not shown in the drawings, for a bubble whose diameter is around 40 μm, it was confirmed that the proportion described above of the voltage V1 of the tracking error signal S2 to the peak value Vp of the voltage V1 is around 100% when return light is received by the optical pickup 2 from above the bubble and that the proportion is around 20% or more across a range of around 510 μm to 550 μm that includes the bubble. Accordingly, when testing for faults on the optical information medium 10, by setting a voltage that is 20% of the peak value Vp of the voltage fluctuation that appears in the tracking error signal S2 during a track jump as a reference voltage Vr and judging whether the voltage V1 of the tracking error signal S2 shown by the error data D1 is equal to or greater than the reference voltage Vr, it is possible to reliably test whether a bubble or foreign matter with a size of 40 μm or larger, which is to be treated as a fault, is present by testing at predetermined intervals (500 μm) in the radial direction of the optical information medium 10. In other words, faults can be found by “sampling” in the radial direction.

Note that although not shown in FIG. 3, when the return light from a bubble or the like is received by the optical pickup 2, the voltage of the focus error signal S1 also fluctuates. However, the voltage of the focus error signal S1 greatly fluctuates only over the bubble itself and the periphery of the bubble, and such fluctuation suddenly decreases as the irradiation position of the laser light moves from the bubble or the like toward the inner periphery or the outer periphery of the optical information medium 10. The reason why the tracking error signal S2 greatly fluctuates over a wider range than the focus error signal S1 is described below. The focus error signal S1 shows the difference between the total of the currents A and C of the two photodiodes Pa, Pc disposed in opposite corners in the virtual square and the total of the currents B and D of the other two photodiodes Pb, Pd disposed in other opposite corners in the virtual square, and therefore is generated by calculation in a direction that cancels out any difference in the amount of light in the direction substantially perpendicular to the track direction of the optical information medium 10 (i.e., in the radial direction of the optical information medium 10). This means that when the irradiation position passes over a deformed part in the periphery of a bubble or foreign matter, even if the currents A, D of the photodiodes Pa, Pd positioned on the same side (the outer periphery side or the inner periphery side) of a track out of the photodiodes Pa, Pb, Pc, and Pd become larger or smaller relative to the currents B, C of the other photodiodes Pb, Pc due to changes in thickness of the light transmitting layer at the deformed part (i.e., due to the deformed part being slanted), the focus error signal S1 generated by calculating (A+C)−(B+D) will not greatly fluctuate. On the other hand, since the tracking error signal S2 shows the difference between the total of the currents A and D of the two photodiodes Pa, Pd positioned on the same side (the inner periphery side or the outer periphery side) of a track on the optical information medium 10 and the total of the currents B and C of the other two photodiodes Pb, Pc, the tracking error signal S2 is generated by calculation in a direction that amplifies any difference in the amount of light in the direction substantially perpendicular to the track direction of the optical information medium 10. This means that when the irradiation position passes over a deformed part in the periphery of a bubble or foreign matter, when the currents A to D of the photodiodes Pa to Pd have changed as described above due to the changes in thickness of the light transmitting layer at the deformed part (i.e., cue to the deformed part being slanted), the tracking error signal S2 generated by calculating (A+D)−(B+C) will greatly fluctuate. Since the fluctuations in the tracking error signal S2 when the irradiation position of the laser light passes the periphery of a fault such as a bubble are due to changes in the thickness of the light transmitting layer at the deformed part located in the periphery of the bubble or the foreign matter as described above (i.e., due to the deformed part being slanted), the fluctuations will resemble fluctuations that appear when the optical information medium 10 itself is tilted. Fluctuations in the tracking error signal S2 due to tilting of the optical information medium 10 are normally corrected automatically when the optical information medium 10 is set in the optical information medium testing apparatus 1. However, correction of tilting of the optical information medium 10 is carried out for the entire optical information medium 10 and is not a process carried out to correct localized faults such as bubbles. This means that even when tilting of the optical information medium 10 has been corrected, when the irradiation position of the laser light passes over a deformed part, a fluctuation of a level that can be used to detect the deformed part is produced in the tracking error signal S2.

Position information for a plurality of target tracks for which the fault testing process is carried out and the reference voltage Vr used in the fault testing process are stored in advance in the storage unit 8. In the present embodiment, to test for the presence of faults such as bubbles with a diameter of around 40 μm, the positions of the target tracks for which the fault testing process is carried out are set at predetermined intervals (500 μm) based on the research described above. Also, data D2 showing the test results of the fault testing process is stored by the calculation control unit 7 in the storage unit 8. The output unit 9 is constructed of a display apparatus, for example, and displays the results of the fault testing process based on the data D2 inputted from the calculation control unit 7.

Next, a testing operation for the optical information medium 10 carried cut by the optical information medium testing apparatus 1 will be described with reference to the drawings.

First, when testing the optical information medium 10, as shown in FIG. 1, the optical information medium 10 is loaded into the optical information medium testing apparatus 1. By doing so, it becomes possible to rotate the optical information medium 10 using the spindle motor 6.

Next, in an operating state of the optical information medium testing apparatus 1, the calculation control unit 7 operates the spindle motor 6 to start rotation of the optical information medium 10. Next, the calculation control unit 7 controls the optical pickup 2 to operate the laser diode 21. By doing so, the laser diode 21 starts emitting the laser light, and the emitted laser light is irradiated onto the optical information medium 10 via the diffraction grating 22, the beam splitter 23, and the objective lens 24. Part of the laser light reflected by the optical information medium 10 passes through the objective lens 24, the beam splitter 23, and the converging lens 26 to become incident on the signal generating unit 27 as return light. In the signal generating unit 27, the optical detector 27a receives the return light, starts to generate currents Ia to If and the signal processing circuit 27b starts to generate the focus error signal S1, the tracking error signal S2, and the information signal S3 based on the currents Ia to If.

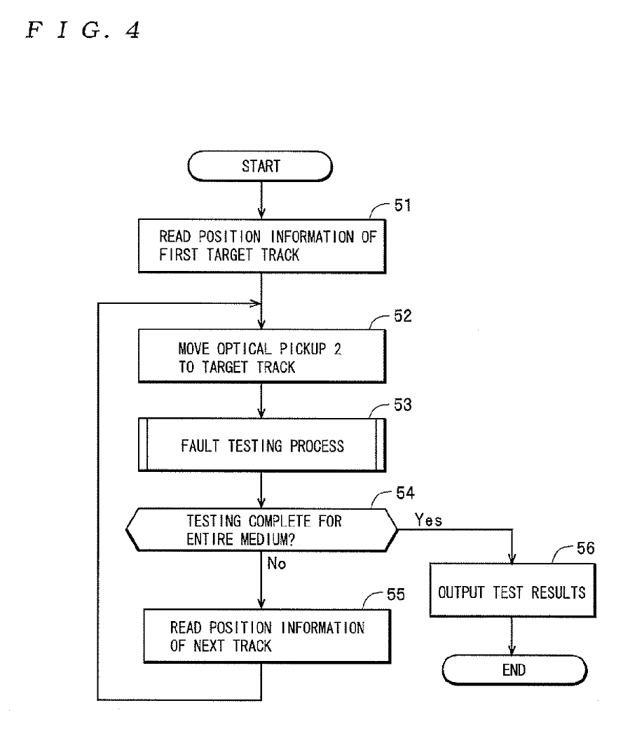

Next, the calculation control unit 7 carries out the testing process shown in FIG. 4. As shown in FIG. 4, in this process, the calculation control unit 7 reads position information of the first target track on which the fault testing process is to be carried out from the storage unit 8 (step 51). Next, by controlling the feed mechanism 5 based on the position information, the calculation control unit 7 moves has the optical pickup 2 to a position above the target track (step 52). When moving the optical pickup 2, the calculation control unit 7 moves the optical pickup 2 to a position over the target track by counting a number of track jumps based on the error data D1. When the movement of the optical pickup 2 has been completed, the servo control unit 3 generates the focus control signal S4 and the tracking control signal S5 based on the focus error signal S1 and the tracking error signal S2 outputted from the optical pickup 2 and thereby starts controlling the two-axis actuator 25. By doing so, the distance between the objective lens 24 and the optical information medium 10 and the position of the objective lens 24 in a direction perpendicular to the tracks are finely adjusted by the two-axis actuator 25, thereby achieving proper focus and tracking servo control.

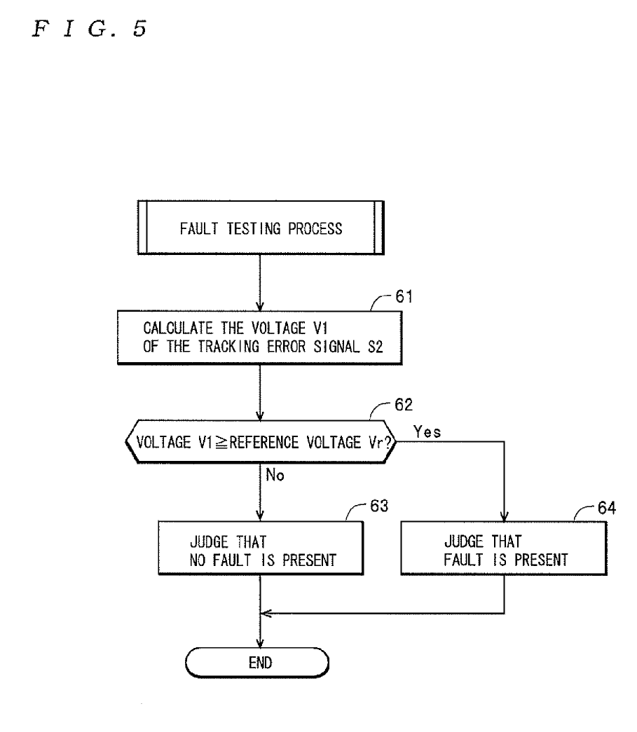

Next, when the laser light from the optical pickup 2 is incident on the target track, the calculation control unit 7 carries out a fault testing process (step 53). As shown in FIG. 5, in the fault testing process, the calculation control unit 7 first calculates the voltage V1 of the tracking error signal S2 based on the error data D1 (step 61). Next, the calculation control unit 7 reads the reference voltage Vr from the storage unit 8 and judges whether the calculated voltage V1 of the tracking error signal S2 is equal to or greater than the reference voltage Vr (step 62). When the result of this judgment is that the voltage V1 of the calculated tracking error signal S2 is below the reference voltage Vr, the calculation control unit 7 judges that there is no fault such as a bubble in a range of 500 μm in the radial direction that includes the present target track (step 63) and stores the result together with the position information of the track in the storage unit 8 as the data D2 showing the test results. On the other hand, when the result of the comparison is that the calculated voltage V1 of the tracking error signal S2 is equal to or greater than the reference voltage Vr, the calculation control unit 7 judges that a fault such as a bubble is present in a range of 500 μm in the radial direction that includes the present track (step 64), and stores the result together with the position information of the track in the storage unit 8 as the data D2. The calculation control unit 7 carries out the process in one of steps 63 and 64 and then completes the fault testing process.

After the fault testing process has been completed, as shown in FIG. 4, the calculation control unit 7 judges whether the fault testing has been completed across the entire optical information medium 10 based, for example, on whether any untested target tracks remain in the storage unit 8 (step 54), and when the testing has not been completed, position information of the next target track is read from the storage unit 8 (step 55), the processing returns to step 52 described above, and the fault testing process continues on the optical information medium 10. By repeatedly carrying out the steps 52 to 55 described above, the calculation control unit 7 carries out fault testing on every target track stored in the storage unit 8. Finally, on judging in step 54 that the fault testing has been completed on every target track, the calculation control unit 7 reads the data D2 showing the test results from the storage unit 8 and outputs the results to the output unit 9, for example (step 56). In this embodiment, since the output unit 9 is constructed of a display apparatus, the output unit 9 displays the test results for every track subjected to testing, based on the inputted data D2. By doing so, the fault testing is completed for the optical information medium 10.

In this way, according to the optical information medium testing apparatus 1 and the method of testing an optical information medium, by having the calculation control unit 7 judge that a fault such as a bubble or foreign matter is present on the optical information medium 10 when the voltage of the tracking error signal S2 generated based on return light from the optical information medium 10 received by the optical pickup 2 is equal to or greater than the reference voltage Vr set in advance, it will be possible to reliably detect a fault such as a bubble or foreign matter in the light transmitting layer (formed by spin coating) of the optical information medium 10 even when the laser light passes over a deformed part in the periphery of the bubble or foreign matter without the laser light passing directly over or in close proximity to the bubble or foreign matter itself, thereby greatly improving the testing precision for the optical information medium 10.

For an optical information medium 10 where a deformed part is present in a wide range in the periphery of a bubble or foreign matter in the light transmitting layer, by using the optical information medium testing apparatus 1 and the method of testing an optical information medium that use the tracking error signal S2 to precisely detect such deformed part, it is possible to reliably detect a fault by testing only two tracks located at predetermined intervals that are sampled out of a plurality of tracks present within a range of the size of the deformed part. This means that by using the optical information medium testing apparatus 1 and the method of testing an optical information medium, since it is possible to test for a fault across the entire optical information medium 10 by merely judging whether a fault is present at predetermined tracks set at intervals within the range of the size of the deformed part, the testing efficiency can be greatly improved.

Note that the present invention is not limited to the construction described above. For example, it is also possible to carry out fault testing for the optical information medium 10 by combining the fault testing of the optical information medium 10 that uses the optical information medium testing apparatus 1 described above (i.e., fault testing that uses the tracking error signal S2) and optical testing that is normally carried out by a conventional optical fault testing apparatus (for example, testing that uses the optical fault testing apparatus disclosed in Japanese Laid-Open Patent Publication No. 2001-241931). With this construction, first after optical testing has been carried out by the optical fault testing apparatus, fault testing of the optical information medium 10 is carried out using the optical information medium testing apparatus 1. By carrying out fault testing on the optical information medium 10 in the mentioned order, it is possible to discard in advance optical information media 10 with large faults found by the optical fault testing apparatus. Although fault testing using the tracking error signal S2 normally requires more time than an optical fault testing apparatus because the fault testing is performed by carrying out focus servo or tracking servo control on the optical information medium 10, it is possible to properly test for smaller faults. Accordingly, by carrying out testing using the optical information medium testing apparatus 1 only on optical information media 10 for which such testing is necessary, it is possible to significantly improve the efficiency of fault testing.

Also, as one example, although an example has been described where the predetermined intervals between tracks to be tested are set at 500 μm in order to test for a fault such as a bubble with an external diameter of 40 μm or larger, it should be obvious that it is possible to set the predetermined intervals between the tracks to be tested in accordance with the size of the bubble and the like treated as a fault, such as by extending the predetermined intervals between the tracks to be tested to 600 μm when testing for a fault such as a bubble with an external diameter of around 43 μm or larger as shown in FIG. 3.

Although an example has been described where the object being tested is the optical information medium 10 where the light transmitting layer is formed by spin coating, the optical information medium testing apparatus 1 and the method of testing an optical information medium according to the present invention can be applied to testing for a fault in the light transmitting layer of an optical information medium where the light transmitting layer is formed by a method aside from spin coating.

What is claimed is:

1. A method of testing an optical information medium, comprising:
comparing a voltage of a tracking error signal generated based on return light from the optical information medium received by an optical pickup and a reference voltage set in advance; and
judging that a fault is present on the optical information medium when the voltage of the tracking error signal is equal to or greater than the reference voltage.

2. A method of testing an optical information medium according to claim 1, wherein testing for the fault using the tracking error signal is carried out at intervals of a predetermined number of tracks.

3. A method of testing an optical information medium according to claim 1, wherein testing for the fault using the tracking error signal is carried out on the optical information medium that has already been tested using an optical fault testing apparatus.

4. An optical information medium testing apparatus, comprising:
an optical pickup that receives return light from an optical information medium and generates a tracking error signal; and
a calculation control unit that compares a voltage of the tracking error signal and a reference voltage set in advance and judges that a fault is present on the optical information medium when the voltage of the tracking error signal is equal to or greater than the reference voltage.

5. An optical information medium testing apparatus according to claim 4, further comprising a reed mechanism that moves the optical pickup in a radial direction of the optical information medium,
wherein the calculation control unit controls the feed mechanism to move the optical pickup in the radial direction while judging whether the fault is present at intervals of a predetermined number of tracks.
